(19) United States
(12) Patent Application Publication
(10) Pub. No.: US 2014/0279235 A1
(43) Pub. Date: Sep. 18, 2014

(54) ENABLING COLLABORATIVE REACTIONS TO IMAGES

(71) Applicant: Thomas E. Sandholm, Sunnyvale, CA (US)

(72) Inventor: Thomas E. Sandholm, Sunnyvale, CA (US)

(21) Appl. No.: 14/352,359

(22) PCT Filed: Dec. 20, 2011
(86) PCT No.: PCT/US2011/066023

§ 371 Date: Apr. 17, 2014

(51) Int. Cl. G06Q 30/06

(52) U.S. Cl. CPC G06Q 30/0613
USPC 705/26.41

(57) ABSTRACT

In one implementation, users associated with user identities are enabled to access, via a collaboration session, an image provided in connection with the collaboration session on behalf of a particular user identity. In addition, a reaction to the image provided on behalf of an individual one of the other user identities is received in connection with the collaboration session, and an association between the received reaction and the image is established that links the received reaction to the image. A user associated with the particular user identity then is enabled to access the received reaction in connection with the collaboration session in a manner that reflects the link between the received reaction and the image.

### BACKGROUND

Computing devices communicatively coupled to one another by wired and/or wireless networks may be capable of exchanging electronic communications with each other. Consequently, such communicatively coupled computing devices may enable users of the communicatively coupled computing devices to communicate with each other even if they are at different locations.

### BRIEF DESCRIPTION OF THE DRAWINGS

FIGS. 1A-1F and 5 are schematic diagrams of example computing devices that illustrate examples of graphical user interfaces (GUIs) for an example of an application for enabling collaborative reactions to images.

FIG. 2 is a block diagram of a communications system.

FIG. 3 is a flow chart that illustrates an example of a process for enabling collaborative reactions to images.

FIG. 4 is a flow diagram that illustrates examples of workflows related to an example of an application for enabling collaborative reactions to images.

### DETAILED DESCRIPTION

A collaboration service executing on a computing system provides on-line collaborative sessions that enable users to share reactions to different images. In one specific example, an application executing on a computing system provides an on-line collaborative shopping session that enables a shopper to share images (e.g., photographs) of items the shopper is considering purchasing with other users. The other users then may share feedback about the items the shopper is considering purchasing with the shopper via the collaborative shopping session in an effort to assist the shopper with the shopper's shopping decisions. In addition, the application also may track which, if any, items the shopper ultimately purchases from among the items the shopper considered purchasing within the context of the collaborative shopping session.

In some implementations, the collaborative shopping session may be temporary. For example, the collaborative shopping session may persist only for a predefined period of time after the collaborative shopping session is launched or only for a predefined period of time during which no activity occurs in connection with the collaborative shopping session (e.g., the shopper does not upload any new images to the collaborative shopping session and/or no new feedback about images uploaded to the collaborative shopping session is received in connection with the collaborative shopping session). Additionally or alternatively, the collaborative shopping session may be terminated responsive to a request to terminate the collaborative shopping session received from the shopper. In some implementations, after the collaborative shopping session ends, the shopper no longer may be allowed to upload images to the collaborative shopping session and/or other users no longer may be allowed to provide feedback about images that have been uploaded to the collaborative shopping session. In some alternative implementations, however, after the collaborative shopping session ends, the shopper may not be allowed to upload new images to the collaborative shopping session, but the shopper nevertheless may be enabled to access a historical view of the collaborative shopping session (e.g., summary information about images uploaded to the collaborative shopping session and associated feedback received from other users).

In some implementations, the application may share information gathered from the collaborative shopping session with one or more third parties (e.g., retail merchants or other business organizations). For example, the application may share with one or more third parties information about which items the shopper was considering purchasing, feedback about the items the shopper was considering purchasing that was received from other users, and/or which, if any, of the items the shopper ultimately purchased. In such implementations, the application may request permission from the shopper and/or the other users engaged in the collaborative shopping session before providing any information from the collaborative shopping session to any third parties. Additionally or alternatively, the application may anonymize information from the collaborative shopping session before providing it to any third parties such that the information from the collaborative shopping session provided to the third parties does not reveal identifying information about the users who generated the information provided to the third parties.

FIGS. 1A-1F are schematic diagrams of example computing devices 100 and 102 that illustrate examples of GUIs for an example of an application for enabling collaborative reactions to images. More particularly, the example GUIs illustrated in FIGS. 1A-1F are for an example of a collaborative shopping application.

Referring first to FIG. 1A, GUI 104 provides a home screen for a shopper using device 100 to participate in a collaborative shopping session, which, in this example, relates to sweaters, but that could be related to any items imaginable. As illustrated in FIG. 1A, GUI 104 includes a selectable “Invite” button 106, a selectable “Take Picture” button 108, a selectable “Enter/Rejoin Chat” button 110, and a selectable “History” button 112. In addition, GUI 104 also includes an image 114 of a sweater that the shopper using device 100 already has uploaded to the collaborative shopping session to provide a visual reminder of the items being considered for purchase by the shopper in connection with the collaborative shopping session.

Device 100 provides touchscreen capabilities enabling a user to select any one of “Invite” button 106, “Take Picture” button 108, “Enter/Rejoin Chat” button 110, and “History” button 112 by contacting (or hovering over) the touchscreen in the vicinity of the button desired to be selected, but any of a variety of different forms of input may be available to a user to enable selection of a particular one of “Invite” button 106, “Take Picture” button 108, “Enter/Rejoin Chat” button 110, and “History” button 112.

Responsive to selection of “Invite” button 106, the collaborative shopping application enables the shopper using device 100 to invite one or more other users to join the collaborative shopping session. For example, in some implementations, the collaborative shopping session may be accessible to users of computing devices via a network address, such as, for example, a uniform resource identifier (URI) like a uniform resource locator (URL). In such implementations, responsive to selection of “Invite” button 106, the collaborative shopping application may provide the network address to the shopper using device 100 so that the shopper may distribute the network address to the other users the shopper desires to invite to join the collaborative shopping session.

As described in greater detail below in connection with FIG. 1B, responsive to selection of “Take Picture” button 108, the collaborative shopping application enables the shopper using device 100 to use device 100 to upload an image, for example, of a sweater the shopper is considering purchasing, to the collaborative shopping session to solicit feedback from the other users engaged in the collaborative shopping session.

As described in greater detail below in connection with FIGS. 1C and 1E, responsive to selection of “Enter/Rejoin Chat” button 110, the collaborative shopping application enables the shopper using device 100 to enter the collaborative shopping session to view feedback, for example, in real-time, about images the shopper has uploaded to the collaborative shopping session received from other users engaged in the collaborative shopping session.

In some implementations, the collaborative shopping session may be implemented as one or more connections (e.g., persistent connections) between a computing system hosting the collaborative shopping session and each of the client devices involved in the collaboration session that enable substantially real-time streaming of communications between the computing system hosting the collaborative shopping session and the client devices involved in the collaboration session. In such implementations, an individual client device may establish a connection with the host computing system by accessing a network address provided, for example, as described above in connection with selectable “Invite” button 106.

As an example, the collaborative shopping session may be implemented as one or more connections between the computing system hosting the collaborative shopping session and the client devices involved in the collaborative shopping session that use the hypertext transfer protocol (HTTP) to exchange messages. More generally, the collaborative shopping session may be implemented according to the Comet, Ajax Push, Reverse Ajax, Two-way-web, HTTP Streaming, or HTTP server push web application models. For example, the collaborative shopping session may utilize a long-held HTTP request to allow the computing system hosting the collaborative shopping session to push communications to a client device involved in the collaborative shopping session without the client device explicitly requesting individual communications. More particularly, the collaborative shopping session may employ streaming techniques including, for example, hidden inline frames (iframes) and/or the XMLHttpRequest (XHR) object. Additionally or alternatively, the collaborative shopping session may employ Ajax with long polling techniques including, for example, XHR long polling and/or script tag long polling. As another option, the collaborative shopping session may employ hypertext markup language (HTML) 5 WebSockets.

In the event that the connection between a particular client device and the host computing system is dropped (or a connection between a particular client device and the host computing system is otherwise inactive for some portion of the collaborative shopping session), the client device may not receive postings to the collaborative shopping session that occur when there is no active connection between the client device and the host computing system. Nevertheless, all of the postings associated with the collaborative shopping session (or some subset of all of the postings associated with the collaborative shopping session (e.g., some predefined number of the m most recent postings associated with the collaborative shopping session)) may be stored in a web page format accessible via a network address associated with the collaborative shopping session such that the postings may be available to the client device even if an active connection was not established between the client device and the host computing system for the entire duration of the collaborative shopping session.

As discussed above, in some cases, a client device, such as, for example, client device 100, participating in the collaborative shopping session may not receive all of the postings associated with the collaborative shopping session. In one particular example, client device 100 may not receive all of the feedback received about images the shopper has uploaded to the collaborative shopping session from other users engaged in the collaborative shopping session. Therefore, the collaborative shopping application may provide a mechanism that enables client device 100 to access a historical view, for example, of all (or some subset of all) the feedback received about images the shopper has uploaded to the collaborative shopping session from other users engaged in the collaborative shopping session.

Referring again to FIG. 1A, responsive to selection of “History” button 112, the collaborative shopping application enables the user to access a historical view, for example, of all (or some subset of all) the feedback received about images the shopper has uploaded to the collaborative shopping session from other users engaged in the collaborative shopping session.

As discussed above, the collaborative shopping application enables the shopper using device 100 to upload an image, for example, of a sweater that the shopper is considering purchasing, to the collaborative shopping session to solicit feedback from the other users engaged in the collaborative shopping session. Referring now to FIG. 1B, GUI 116 enables the shopper using device 100 to upload an image to the collaborative shopping session.

For instance, the shopper using device 100 may use native photographic capabilities of device 100 (e.g., an embedded camera and associated hardware and software) to take a photograph of a sweater the shopper is considering purchasing and then interact with GUI 116 in order to upload the photograph to the collaborative shopping session. Additionally or alternatively, the shopper using device 100 may use native photographic capabilities of device 100 to take a photograph of a quick response (QR) code or some other form of bar code associated with the sweater the shopper is considering purchasing. An application executing on device 100 or a hosted device to which device 100 is communicatively coupled then may decode the photographed bar code and identify, based on the decoded bar code, a photograph corresponding to the sweater that the shopper is considering purchasing.

Referring again to FIG. 1B, after an image 118 of a sweater to be uploaded to the collaborative shopping session has been identified, the identified image 118 is displayed within GUI 116. In addition, GUI 116 also may display additional information about the image 118 to be uploaded or the sweater represented by the image to be uploaded including, for example, the global positioning system (GPS) coordinates 120 and/or street address 122 of the location at which the image was identified (or the location from which the image 118 is uploaded from device 100 to the collaborative shopping session). Additionally or alternatively, GUI 116 also may display information about the store 124 from which the shopper is considering purchasing the sweater, a product name 126 for the sweater being considered for purchase, and the price 128 being charged by the store for the sweater being considered for purchase.

In some implementations, device 100 may be GPS-equipped and, therefore, able to identify its location as a consequence of communicating with different GPS satellites. In such implementations, when the shopper using device 100 uses the native photographic capabilities of device 100 to take a photograph of a sweater the shopper is considering purchasing or a QR or other bar code associated with the sweater the shopper is considering purchasing, device 100 may determine the location (e.g., GPS coordinates) at which the photograph was taken. The location information displayed in GUI 116 (e.g., GPS coordinates 120 and/or street address 122) for the image 118 then may be populated automatically based on the location of where the photograph was taken as determined by device 100. In some implementations, the identified geographic location may be used to resolve the location of the device to a particular store, and the collaborative shopping application may infer that the shopper is considering purchasing the sweater from the store. For example, the identified geographic location may be compared to a database or other data structure that maps geographic locations to stores in order to identify a particular store corresponding to the identified geographic location.

Alternatively, device 100 may determine the location of the device 100 when the shopper using device 100 interacts with GUI 116 to cause the image 118 to be uploaded to the collaborative shopping session. This determined location of device 100 at the time image 118 is uploaded to the collaborative shopping session then may be associated with image 118 and used to populate the location information of GUI 116 (instead of or in addition to the location at which the photograph was taken if the location at which the photograph was taken is different from the location from which the image 118 is uploaded to the collaborative shopping session).

Additionally or alternatively, when the shopper using device 100 uses the native photographic capabilities of device 100 to take a photograph of a QR or other bar code associated with a sweater the shopper is considering purchasing, the decoded QR or bar code may provide information about the location and/or identity of the store from which the shopper is considering purchasing the sweater, the product name for the sweater the shopper is considering purchasing, and/or the price being charged for the sweater by the store from which the shopper is considering purchasing the sweater. In such cases, any or all of the location information (including GPS coordinates 120 and/or street address 122), store name 124, product name 126, and price 128 may be automatically populated within GUI 128 based on information obtained from the decoded QR or bar code.

In addition to automatically populating any or all of location information (including GPS coordinates 120 and/or street address 122), store name 124, product name 126, and price 128, GUI 116 may provide mechanisms that enable the shopper using device 100 to manually input any or all of location information (including GPS coordinates 120 and/or street address 122), store name 124, product name 126, and price 128.

GUI 116 also includes a selectable “Post” button 130. Responsive to selection of “Post” button 130, the collaborative shopping application causes the image 118 of the sweater displayed within GUI 116 and, in some implementations, any or all of location information (including GPS coordinates 120 and/or street address 122), store name 124, product name 126, and price 128 associated with image 118 to be uploaded to the collaborative shopping session. Additionally, a time stamp (e.g., indicating the time at which the image 118 was generated and/or uploaded to the collaborative shopping session) as well as an indication of the particular collaborative shopping session to which the image corresponds may be uploaded to the collaborative shopping session as well.

After the shopper using device 100 uploads an image from device 100 to the collaborative shopping session, the image may be made available to other users engaged in the collaborative shopping session via the computing devices the other users are using to participate in the collaborative shopping session.

FIGS. 1C and 1E are schematic diagrams of a computing device 102 that illustrate different examples of GUIs 132 and 134 displayed to a user participating in the collaborative shopping session after having been invited to participate by the shopper.

Referring first to FIG. 1C, GUI 132 displays images 114, 118, 136, and 138 of sweaters uploaded to the collaborative shopping session by the shopper.

In addition, for each displayed image 114, 118, 136, and 138, GUI 132 provides selectable preference voting buttons, namely a selectable “Yes” button 139, a selectable “No” button 140, and a selectable “Maybe” button 141, that enable the user of device 102 to indicate whether the user is: (1) in favor of the shopper purchasing the sweater represented in the corresponding image (e.g., by selecting “Yes” button 139); (2) against the shopper purchasing the sweater represented in the corresponding image (e.g., by selecting “No” button 140); or (3) indifferent when it comes to the shopper's potential purchase of the sweater represented in the corresponding image (e.g., by selecting “Maybe” button 141).

For each displayed image 114, 118, 136, and 138, GUI 132 also includes a selectable “Details” control 142 (e.g., a hyperlink). Responsive to selection of the “Details” control 142 for a particular one of the images 114, 118, 136, and 138 displayed in GUI 132, the collaborative shopping application provides more detailed information about the sweater represented in the corresponding one of the images 114, 118, 136, and 138. For example, responsive to selection of the “Details” control 142 for a particular one of the images 114, 118, 136, and 138 displayed in GUI 132, the collaborative shopping application may display any or all of location information (including GPS coordinates and/or street address), store name, product name, and price associated with the sweater represented in the corresponding one of the images 114, 118, 136, and 138.

In some implementations, the order in which the images 114, 118, 136, and 138 displayed in GUI 132 are arranged may be based on the order in which the shopper uploaded the images 114, 118, 136, and 138 to the collaborative shopping session. For example, the images 114, 118, 136, and 138 displayed in GUI 132 may be displayed from top to bottom in the order in which the shopper uploaded the images 114, 118, 136, and 138 to the collaborative shopping session with the first image the shopper uploaded to the collaborative shopping session being displayed at the top of GUI 132 and the most recent image the shopper uploaded to the collaborative shopping session being displayed at the bottom of GUI 132. Alternatively, the images 114, 118, 136, and 138 displayed in GUI 132 may be displayed from bottom to top in the order in which the shopper uploaded the images 114, 118, 136, and 138 to the collaborative shopping session with the first image the shopper uploaded to the collaborative shopping session being displayed at the bottom of GUI 132 and the most recent image the shopper uploaded to the collaborative shopping session being displayed at the top of GUI 132.

In addition, in some implementations, if additional images have been uploaded to the collaborative shopping session by the shopper, GUI 132 may be scrollable up and/or down to enable a user of device 102 to access the additional images uploaded to the collaborative shopping session by the shopper.

Responsive to selection of one of the “Yes” button 139, the “No” button 140, and the “Maybe” button 141 for a particular one of the images 114, 118, 136, and 138 displayed in GUI 132, the collaborative shopping application records the appropriate “Yes,” “No,” or “Maybe” preference vote for the corresponding one of the images 114, 118, 136, and 138. In addition, in some implementations, after a preference vote for a particular one of the images 114, 118, 136, and 138 displayed in GUI 132 has been input and/or recorded, that image and its corresponding preference voting buttons may be removed from GUI 132.

The same GUI 132 illustrated in FIG. 1C or a similar GUI may be made available to each user participating in the collaborative shopping session, thereby enabling multiple participating users to provide preference votes for the different sweaters being considered for purchase by the shopper in connection with the collaborative shopping session. As preference votes for the different sweaters are recorded for different users participating in the collaborative shopping session, the preference votes may be compiled and made available to the shopper in an effort to help inform the shopper's purchasing decision.

Referring now to FIG. 1D, GUI 143 is an example of a GUI presenting a view of preference votes compiled from different users participating in the collaborative shopping session for the different images 114, 118, 136, and 138 uploaded to the collaborative shopping session by the shopper using device 100. In particular, as illustrated in FIG. 1D, GUI 143 presents the number of “Yes,” “No,” and “Maybe” votes recorded on behalf of other users participating in the collaborative shopping session for each of the different images 114, 118, 136, and 138. In some implementations, as new preference votes are recorded in connection with different ones of images 114, 118, 136, and 138, GUI 143 may update the displayed preference vote tallies substantially in real-time.

In addition, a selectable “View” control 144 (e.g., a hyperlink) is displayed beside each preference vote tally. Responsive to selection of a “View” control 144 beside a particular preference vote tally, GUI 143 surfaces indications of the different users participating in the collaborative shopping session who contributed to the particular preference vote tally.

Like GUI 132 of FIG. 1C, for each displayed image 114, 118, 136, and 138, GUI 143 also includes a selectable “Details” control 142 (e.g., a hyperlink). Responsive to selection of the “Details” control 142 for a particular one of the images 114, 118, 136, and 138 displayed in GUI 143, the collaborative shopping application provides more detailed information about the sweater represented in the corresponding one of the images 114, 118, 136, and 138. For example, responsive to selection of the “Details” control 142 for a particular one of the images 114, 118, 136, and 138 displayed in GUI 143, the collaborative shopping application may display any or all of location information (including GPS coordinates and/or street address), store name, product name, and price associated with the sweater represented in the corresponding one of the images 114, 118, 136, and 138.

Referring now to FIG. 1E, in contrast to GUI 132 of FIG. 1C, GUI 134 is an alternative example of a GUI displayed to a user participating in the collaborative shopping session that enables the user to provide reactions to the displayed images 114, 118, 136, and 138 in a textual format instead of selecting from among predefined preference voting options (e.g., “Yes,” “No,” or “Maybe”). As illustrated in FIG. 1E, for each displayed image 114, 118, 136, and 138, GUI 134 provides a comment field 146 and a selectable “Submit” button 148. Each comment field 146 is configured to receive textual input, thereby enabling the user of device 102 to provide a reaction to the corresponding image in a textual format. Responsive to entry of textual input into a comment field 146 corresponding to a particular one of the images 114, 118, 136, and 138 and the subsequent selection of the corresponding “Submit” button 148, the collaborative shopping application records the text input in the comment field 146 as a reaction associated with the particular image. In addition, in some implementations, after the reaction to the particular image has been input and/or recorded, that image and its corresponding comment field 146 and “Submit” button 148 may be removed from GUI 132.

Like GUI 132 of FIG. 1C, for each displayed image 114, 118, 136, and 138, GUI 134 also includes a selectable “Details” control 142 (e.g., a hyperlink). Responsive to selection of the “Details” control 142 for a particular one of the images 114, 118, 136, and 138 displayed in GUI 134, the collaborative shopping application provides more detailed information about the sweater represented in the corresponding one of the images 114, 118, 136, and 138. For example, responsive to selection of the “Details” control 142 for a particular one of the images 114, 118, 136, and 138 displayed in GUI 134, the collaborative shopping application may display any or all of location information (including GPS coordinates and/or street address), store name, product name, and price associated with the sweater represented in the corresponding one of the images 114, 118, 136, and 138.

In implementations in which reactions to the images uploaded to the collaborative shopping session are solicited in textual format, the same GUI 134 illustrated in FIG. 1E or a similar GUI may be made available to each user participating in the collaborative shopping session, thereby enabling multiple participating users to provide textual reactions to the different sweaters being considered for purchase by the shopper in connection with the collaborative shopping session. As reactions to the different sweaters are recorded for different users participating in the collaborative shopping session, the reactions may be made available to the shopper in an effort to help inform the shopper's purchasing decision.

Referring now to FIG. 1F, GUI 152 is an example of a GUI presenting a view of textual reactions from different users participating in the collaborative shopping session for the different images 114, 118, 136, and 138 uploaded to the collaborative shopping session by the shopper using device 100. In particular, as illustrated in FIG. 1F, GUI 152 presents different textual reactions recorded on behalf of other users participating in the collaborative shopping session for each of the different images 114, 118, 136, and 138. In addition, beside each textual reaction displayed in GUI 152 is an indication 154 of the participating user who provided the textual reaction. A variety of different indications may be used to identify a participating user who provided a textual reaction. For example, any one or more of a photograph, an image, an avatar, or text may be used to identify a participating user. Alternatively, in some implementations, the identities of participating users who provided textual reactions may not be revealed.

In some cases, for the convenience of display, GUI 152 may not display all of the textual reactions recorded for any particular one of images 114, 118, 136, and 138 at the same time. In such cases, GUI 152 may provide a selectable “More” control 156 for each image for which not all of the recorded textual reactions are displayed. Responsive to selection of a “More” control 156 for a particular image, GUI 152 may display one or more of the textual reactions to the image not currently displayed. Furthermore, as with GUI 143 of FIG. 1D, in some implementations, as new textual reactions are recorded in connection with different ones of images 114, 118, 136, and 138, GUI 152 may update the displayed textual reactions substantially in real-time.

In addition, for each displayed image 114, 118, 136, and 138, GUI 152, like GUI 143 of FIG. 1D, also includes a selectable “Details” control 142 (e.g., a hyperlink). Responsive to selection of the “Details” control 142 for a particular one of the images 114, 118, 136, and 138 displayed in GUI 152, the collaborative shopping application provides more detailed information about the sweater represented in the corresponding one of the images 114, 118, 136, and 138. For example, responsive to selection of the “Details” control 142 for a particular one of the images 114, 118, 136, and 138 displayed in GUI 152, the collaborative shopping application may display any or all of location information (including GPS coordinates and/or street address), store name, product name, and price associated with the sweater represented in the corresponding one of the images 114, 118, 136, and 138.

The reactions to the sweaters represented in the different images uploaded by the shopper to the collaborative shopping session may be helpful to the shopper in making purchasing decisions. In addition, this information also may be valuable to one or more other third parties (e.g., business organizations like retail merchants) not directly involved in the collaborative shopping session itself. For example, such third parties may find information about which sweaters the shopper was considering for purchase and the feedback received about each such sweater to be valuable. Therefore, in some implementations, the collaborative shopping application may provide information about which sweaters the shopper was considering for purchase and/or the feedback received about each such sweater to one or more third parties. In addition, such third parties also may find information about which, if any, of the sweaters the shopper ultimately decided to purchase to be valuable. Therefore, in some implementations, the collaborative shopping application may solicit information from the shopper about which, if any, of the sweaters from the collaborative shopping session the shopper ultimately purchased and, responsive to receipt of such information about which, if any, of the sweaters the shopper ultimately purchase, provide the received information about which, if any, of the sweaters the shopper ultimately purchased to one or more third parties.

FIG. 2 is a block diagram 200 of a communications system. As illustrated in FIG. 2, a first client device 202, second client devices 204(a)-204(n), and a computing system 206 hosting an on-line collaborative image reaction sharing application are communicatively coupled by a network 208. For illustrative purposes, several elements illustrated in FIG. 2 and described below are represented as monolithic entities. However, these elements each may include and/or be implemented on numerous interconnected computing devices and other components that are designed to perform a set of specified operations.

Network 208 may provide direct or indirect communication links between first client device 202, second client devices 204(a)-204(n), and computing system 206. Examples of network 208 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data, as well as combinations of any of the foregoing.

Computing system 206 may be implemented using one or more computing devices (e.g., servers) configured to host an online collaborative image reaction sharing application that can be accessed from client devices (e.g., first client device 202 and second client devices 204(a)-204(n)) connected to computing system 206 over network 208. The one or more computing devices on which computing system 206 is implemented each may include one or more processors 210 for executing instructions stored in storage and/or received from one or more other electronic devices, for example over network 208.

Furthermore, the one or more computing devices on which computing system 206 is implemented may have internal or external storage components storing data, such as, for example, application data 212, and computer-readable instructions that implement programs such as an operating system and one or more application modules, such as, for example, collaborative session management model 214 and reporting module 216. In addition, the computing devices on which computing system 206 is implemented also typically include network interfaces and communication devices for sending and receiving data, for example over network 208.

When executed by the processors 210 of the computing system 206, the computer-readable instructions that implement the application modules and that are stored in the storage components accessible to computing system 206 may operate to provide the on-line collaborative image reaction sharing application hosted by computing system 206. For example, when executed by the processors 210 of the computing system 206, the computer-readable instructions that implement the collaborative session management module 214 may operate to enable first client device 202 and one or more of second client devices 204(a)-204(n) to engage in a collaborative session via which, as described more fully throughout, a user of first client device 202 shares images and the user(s) of the one or more second client devices 204(a)-204(n) provide reactions to the images. Additionally, when executed by the processors 210 of the computing system 206, the computer-readable instructions that implement the reporting module 216 may operate to generate reports which, as described more fully throughout, reflect information gleaned from one or more collaborative sessions facilitated by the collaborative session management module 214 including, such as, for example, items considered for purchase by shoppers, feedback provided about such items by other users, and/or items ultimately purchased by the shoppers. The computer-readable instructions that implement the reporting module 216, when executed by the processors 210 of the computing system 206, also may operate to transmit such reports to one or more third parties (e.g., business organizations such as retail merchants).

The storage components storing application data 212 may store a variety of different data related to the on-line collaborative image reaction sharing application hosted by computing system 206. For example, the storage components storing application data 212 may store images that represent items being considered for purchase by shoppers that have been uploaded to collaborative sessions; information about such items being considered for purchase such as location, store, product name, and price; feedback provided about such items by other users; and/or items ultimately purchased by the shoppers.

Each of first client device 202 and second client devices 204(a)-204(n) may be any of a number of different types of computing devices including, for example, a personal computer, a special purpose computer, a general purpose computer, a combination of a special purpose and a general purpose computer, a laptop computer, a tablet computer, a netbook computer, a smart phone, a mobile phone, and a personal digital assistant. In addition, each of first client device 202 and second client devices 204(a)-204(n) may have internal or external storage components for storing data and programs such as an operating system and one or more application programs, for example, for use in accessing the application hosted by computing system 206. Each of first client device 202 and second client devices 204(a)-204(n) also typically includes one or more central processing units (CPUs) for executing instructions stored in storage and/or received from one or more other electronic devices, for example over network 208. Furthermore, each of first client device 202 and second client devices 204(a)-204(n) also usually includes one or more network interfaces and communication devices for sending and receiving data, for example over network 208.

In some implementations, the storage components for one or more of first client device 202 and second client devices 204(a)-204(n) may store a client application specifically configured to access the on-line collaborative image reaction sharing application hosted by computing system 206. Additionally or alternatively, the storage components for one or more of first client device 202 and second client devices 204(a)-204(n) may store a more generalized application (e.g., a web browser and/or a web browser with appropriate plug-ins, such as, for example, a Java applet or Adobe Flash, installed) that enables access to a variety of different on-line applications including the on-line collaborative image reaction sharing application hosted by computing system 206. In either case, by accessing the on-line collaborative image reaction sharing application hosted by computing system 206, first client device 202 and one or more of second client devices 204(a)-204(n) may be able to engage in a collaborative session via which, as described more fully throughout, a user of first client device 202 shares images and the user(s) of the one or more second client devices 204(a)-204(n) provide reactions to the images.

FIG. 3 is a flow chart 300 illustrating an example of a process for enabling collaborative reactions to images. The process illustrated in the flowchart 300 of FIG. 3 may be performed by a computing system such as computing system 206 illustrated in FIG. 2.

At 302, a collaboration session is launched. In some cases, the collaboration session may be launched in response to a request from a client device corresponding to a leader user identity. Furthermore, depending on the implementation, a variety of different types of collaboration sessions may be employed. For example, in some implementations, the collaboration session may be implemented as a chat room. In one specific example, the collaboration session is implemented as connections between the computing system hosting the collaboration session (e.g., computing system 206 of FIG. 2) and each of the client devices involved in the collaboration session that use the HTTP protocol to exchange messages. In some implementations, participation in the collaboration session may be limited to a restricted group of participants. For example, authentication mechanisms (e.g., user name and password pairs) may be used to regulate access to the collaboration session such that only a restricted group of participants are able to participate in the collaboration session. Additionally or alternatively, information enabling access to the collaboration session (e.g., a network address associated with the collaboration session) only may be provided to a limited group of participants.

At 304, one or more images are received in connection with the collaboration session. For example, in cases where the collaboration session is implemented as HTTP channels between the computing system hosting the collaboration session and the client devices involved in the collaboration session, the client device corresponding to the leader user identity for the collaboration session may upload the image(s) to the host computing system via the HTTP channel between the client device and the host computing system. For instance, the client device corresponding to the leader user identity may be instructed to upload the image(s) to the host computing system via a GUI such as the GUI 116 of FIG. 1B. As a consequence of the client device corresponding to the leader user identity uploading the image(s) to the host computing system via the HTPP channel between the client device and the host computing system, the host computing system may receive the uploaded image(s).

Then, at 306, access to the received image(s) by other client devices is enabled via the collaboration session. For example, in cases where the collaboration session is implemented as HTTP connections between the computing system hosting the collaboration session and the client devices involved in the collaboration session, the host computing system may make the images received from the client device corresponding to the leader user identity to the other client devices with which the host computing system has established HTTP connections. In such implementations, the host computing system may use the established HTTP connections to push the image(s) received from the client device corresponding to the leader user identity to the other client devices with which the host computing system has established HTTP connections. The other client devices may include listeners that wait for the image(s) to be pushed to them by the host computing system and facilitate the transfer of the image(s) to the other client devices responsive to detecting that the host computing system is pushing the image(s) to the other client devices between which the host computing system has established HTTP connections. Alternatively, the other client devices may use the established HTTP connections to poll (e.g., periodically or aperiodically) the host computing system to determine if one or more new images have been received by the host computing system, and, in the event that one or more new images have been received by the host computing system, the host computing system may initiate a transfer of the images to the other client devices responsive to their polling using the established HTTP connections. After the other client devices have received the image(s), the other client devices may display the image(s) via a GUI that solicits user reaction(s) to the image(s) such as the GUI 132 of FIG. 1C or the GUI 134 of FIG. 1E.

After enabling access to the received image(s) via the collaboration session, reactions to the image(s) are received in connection with the collaboration session at 308. For example, in cases where the collaboration session is implemented as HTTP connections between the computing system hosting the collaboration session and the client devices involved in the collaboration session, users of the other client devices may input reactions to one or more of the images received from the client device corresponding to the leader user identity, and, responsive to such input, the other client devices may initiate transfers of the reactions to the image(s) to the host computing system via the HTTP connections established between the host computing system and the other client devices. For instance, the other client devices may be instructed to initiate transfers of user reaction(s) to the image(s) to the host computing system via a GUI such as the GUI 132 of FIG. 1C or the GUI 134 of FIG. 1E. As a consequence of the other client devices initiating the transfers of the reactions to the image(s) via the HTTP connections between the host computing system and the other client devices, the host computing system may receive the reactions to the image(s).

At 310, after reactions to the image(s) have been received, associations are established between the received reaction(s) and the image(s) to which the received reaction(s) correspond in a manner that links the received reaction(s) to the image(s) to which the received reaction(s) correspond. For example, in some implementations, the other cent devices that transmit reactions to the host computing device may include indications of the images to which the transmitted reactions correspond within the transmitted reactions such that individual received reactions include indications of the images to which they correspond. In such implementations, the host computing system may establish associations between the received reactions and the images to which they correspond based on the indications received with the reactions.

After reactions to the image(s) have been received, access to the received reactions is enabled in connection with the collaboration session in a manner that reflects the link(s) between the received reaction(s) and the image(s). For example, in cases where the collaboration session is implemented as HTTP connections between the computing system hosting the collaboration session and the client devices involved in the collaboration session, the host computing system may make the reaction(s) received from the other client devices available to the client device corresponding to the leader user identity over the HTTP connection established between the host computing system and the client device. In such implementations, the host computing system may use the established HTTP connection to push the reaction(s) received from the other client devices to the client device corresponding to the leader user identity. The client device may include a listener that waits for the reaction(s) to be pushed to ii by the host computing system and that facilitates the transfer of the reaction(s) to the client device corresponding to the leader user identity responsive to detecting that the host computing system is pushing the reaction(s) to the client device. Alternatively, the client device corresponding to the leader user identity may use the established HTTP connections to poll (e.g., periodically or aperiodically) the host computing system to determine if one or more new reactions have been received by the host computing system, and, in the event that one or more new reactions have been received by the host computing system, the host computing system may initiate a transfer of the reaction(s) to the client device responsive to client device's polling using the established HTTP connection.

After the client device corresponding to the user leader identity has received the reaction(s) to the image(s), the client device corresponding to the user leader identity may display the reaction(s) to the image(s) via a GUI such as the GUI 143 of FIG. 1D or the GUI 152 of FIG. 1F. As illustrated in FIG. 1D, GUI 143 displays reactions to images 114, 118, 136, and 1148 in a manner that reflects the links between the reactions and their corresponding images by displaying the reactions substantially adjacent to their corresponding images. Similarly, as illustrated in FIG. 1F, GUI 152 displays reactions to images 114, 118, 136, and 1148 in a manner that reflects the links between the reactions and their corresponding images by displaying the reactions substantially adjacent to their corresponding images.

FIG. 4 is a flow diagram 400 that illustrates workflows related to an application for enabling collaborative reactions to images. As discussed above, an application for enabling collaborative reactions to images may involve multiple different computing systems. For example, the application for enabling collaborative reactions to images may be hosted by a host computing system (e.g., computing system 206 illustrated in FIG. 2). In addition, the application for enabling collaborative reactions to images may receive input from and transmit output to a client computing device corresponding to a leader user identity (e.g., first client device 202 illustrated in FIG. 2) while also receiving input from and transmitting output to one or more other client devices (e.g., second client devices 204(a)-204(n) illustrated in FIG. 2).

Therefore, the flow diagram 400 of FIG. 4 illustrates examples of workflows for a host computing system 402 hosting an application for enabling collaborative reactions to images; a client computing device 404 corresponding to a leader user identity; and one or more other client computing devices 406. In addition, the flow diagram 400 of FIG. 4 illustrates examples of how the workflows for the host computing system 402, client computing device 404, and client computing device(s) 406 may relate to one another. For example, the broken lines in FIG. 4 illustrate examples of communications that may be exchanged between host computing system 402 and client computing device 404 as well as host computing system 402 and client computing device(s) 406. In addition to illustrating examples of communications exchanged between host computing system 402 and client computing device 404 as well as host computing system 402 and client computing device(s) 406, the broken lines in FIG. 4 also may illustrate the relative timing of such exchanged communications.

At 408, client device 404 transmits a request to the host computing system 402 to initiate a collaboration session. In some implementations, the request may include, be accompanied by, or otherwise be associated with an indication of one or more additional user identities to be invited to participate in the collaboration session. For example, in some implementations, e-mail addresses for one or more participants to be invited to the collaboration session may be provided to host computing system 402. However, other indications of user identities to be invited to participate in the collaboration session may be provided in addition (or as an alternative) to e-mail addresses. For example, in some implementations, application user names and/or social network contact names may be provided to host computing system 402 to enable other participants to be invited to the collaboration session.

At 410, host computing system 402 receives the request to initiate the collaboration session from client computing device 404 and establishes a collaboration session in response. As discussed above, host computing system 402 may establish any of a number of different types of collaboration sessions. In one particular example, the collaboration session may be implemented as an HTTP connection between host computing device 402 and client device 404 and one or more HTTP connections between host computing device 402 and the client device(s) 406 associated with other user identities invited to participate in the collaboration session. In such an example implementation, the collaboration session may be accessible via a network address (e.g., a URL), and HTTP connections between host computing system 402 and dent device 404 and client device(s) 406 may be established responsive to client device 404 and client device(s) 406 accessing the network address for the collaboration session.

Therefore, at 412, host computing system 402 distributes the network address associated with the collaboration session to client device 404 and client device(s) 406. In alternative implementations, host computing system 402 may distribute the network address associated with the collaboration session only to client device 404, for example, due to the fact that client device 404 requested the collaboration session. In such implementations, client device 404 then may be responsible for transmitting the network address associated with the collaboration session to the one or more other user identities to be invited to participate in the collaboration session. For example, client device 404 may generate and transmit e-mail messages to the one or more other user identities to be invited to participate in the collaboration session in order to communicate the network address associated with the collaboration session to the one or more other user identities to be invited to participate in the collaboration session.

At 414, client computing device 404 receives the network address for the collaboration session, and, at 416, client computing device(s) 406 receive the network address for the collaboration session. Then, at 418, client computing device 404 transmits a request to access the collaboration session as a leader to host computing system 402. For example, in implementations in which the collaboration session is implemented as an HTTP connection between host computing system 402 and client computing device 404 and one or more HTTP connections between host computing system 402 and client computing device(s) 406, the request transmitted to host computing system 402 by client computing device 404 to access the collaboration session as a leader may be a request to establish an HTTP connection between host computing system 402 and client computing device 404 that is associated with a leader role in the collaboration session.

Meanwhile, at 420, host computing system 402 determines whether access to the collaboration session as a leader has been requested. Had no new requests to access the collaboration session as a leader been received, host computing system 402 would have proceeded directly to 428. However, because client computing device 404 had requested access to the collaboration session as a leader, host computing system 402 proceeds to 422, where host computing system 402 adds client computing device 404 to the collaboration session as a leader. For example, in implementations in which the collaboration session is implemented as an HTTP connection between host computing system 402 and client computing device 404 and one or more HTTP connections between host computing system 402 and client computing device(s) 406, host computing system 402 may establish an HTTP connection between host computing system 402 and client computing device 404 that is associated with a leader role in the collaboration session. At 424, client computing device 404 then joins the collaboration session as a leader. In some implementations, multiple different client computing devices may be allowed to join the collaboration session as leaders. In alternative implementations, only one client computing device may be allowed to join the collaboration session in the role of a leader.

At 426, one or more client computing devices 406 associated with user identities invited to participate in the collaboration session transmit requests to access the collaboration session as participants. For example, in implementations in which the collaboration session is implemented as an HTTP connection between host computing system 402 and client computing device 404 and one or more HTTP connections between host computing system 402 and client computing device(s) 406, the requests transmitted to host computing system 402 by client computing device(s) 406 to access the collaboration session as participants may be requests to establish HTTP connections between host computing system 402 and client computing device(s) 406 that are associated with participant roles in the collaboration session.

Meanwhile, at 428, host computing system 402 determines whether access to the collaboration session as a participant has been requested. Had no new requests to access the collaboration session as a participant been received, host computing system 402 would have proceeded directly to 438. However, because access to the collaboration session as a participant had been requested by one or more client computing devices 406, host computing system 402 proceeds to 430, where host computing system 402 adds client computing device(s) 406 to the collaboration session as participants. For example, in implementations in which the collaboration session is implemented as an HTTP connection between host computing system 402 and client computing device 404 and one or more HTTP connections between host computing system 402 and client computing device(s) 406, host computing system 402 may establish HTTP connections between host computing system 402 and client computing device(s) 406 that are associated with participant roles in the collaboration session. At 432, client computing device(s) 406 then join the collaboration session as participants.

At 434, client computing device 404 determines whether a user instruction to upload a photograph to the collaboration session has been received. If client computing device 404 determines that a new user instruction to upload a photograph to the collaboration session has not been received, client computing device 404 proceeds to 456. Alternatively, in the event that a user instruction to upload a photograph to the collaboration session has been received, client computing device 404 proceeds to 436, where client computing device 404 uploads the photograph to the collaboration session. For example, in implementations in which the collaboration session is implemented as an HTTP connection between host computing system 402 and client computing device 404 and one or more HTTP connections between host computing system 402 and client computing device(s) 406, client computing device 404 may upload the photograph to the collaboration session via the HTTP connection established between client computing device 404 and host computing system 402.

Meanwhile, at 438, host computing system 402 determines whether a new photograph has been uploaded to the collaboration system within a predetermined period of time either from when the collaboration session was established or from when the last photograph was uploaded to the collaboration session, if host computing system 402 determines that no new photograph has been received within the predetermined period of time either from when the collaboration session was established or from when the last photograph was uploaded to the collaboration session, host computing system 402 determines that the collaboration session has timed out and proceeds to 460, where the collaboration session is terminated. Alternatively, in the event that host computing system 402 determines that one or more new photographs have been received before the collaboration session times out, host computing system 402 proceeds to 440, where host computing system stores the photograph(s) newly uploaded to the collaboration session and distributes the newly uploaded photograph(s) to client computing device(s) 406 engaged in the collaboration session as participants. For example, in implementations in which the collaboration session is implemented as an HTTP connection between host computing system 402 and client computing device 404 and one or more HTTP connections between host computing system 402 and client computing device(s) 406, host computing device 402 may use the one or more HTTP connections between host computing system 402 and client computing device(s) 406 to transmit an indication to client computing device(s) 406 that the newly uploaded photograph(s) are ready to be downloaded.

Meanwhile, at 442, client computing device(s) 406 determine whether there are any new photographs that have been uploaded to the collaboration session that are available for download. If the client computing device(s) 406 determine that any photographs are available for download, the client computing device(s) 406 proceed to 444, where the client computing device(s) 406 download the photograph(s). For example, in implementations in which the collaboration session is implemented as an HTTP connection between host computing system 402 and client computing device 404 and one or more HTTP connections between host computing system 402 and client computing device(s) 406, client computing device(s) 406 may include listeners to detect communications within the established HTTP connection(s) from host computing system 402 indicating that photographs are available for download and to trigger download of such photographs via the established HTTP connection(s) in response. Alternatively, if the client computing devices 406 determine that no new photographs are available for download, the client computing device(s) 406 proceed to 446.

At 446, client computing device(s) 406 determine whether new user feedback has been provided for any of the photographs that have been downloaded to the client computing device(s) 406 in connection with the collaboration session. If the client computing device(s) 406 determine that no new user feedback has been provided, the client computing device(s) 406 return to 442 and again determine whether there are any new photographs that have been uploaded to the collaboration session that are available for download. Alternatively, if the client computing device(s) 406 determine that new user feedback has been provided for any of the photographs that have been downloaded to the client computing device(s) 406, the client computing device(s) 406 proceed to 448, where the client computing device(s) 406 upload the new user feedback to the host computing system 402. For example, in implementations in which the collaboration session is implemented as an HTTP connection between host computing system 402 and client computing device 404 and one or more HTTP connections between host computing system 402 and client computing device(s) 406, client computing device(s) 406 may use the HTTP connection(s) between host computing system 402 and client computing device(s) 406 to upload the newly received user feedback to the host computing system 402. The feedback uploaded to the collaboration session may include or otherwise be accompanied by an indication of the image to which it corresponds.

Meanwhile, at 450, host computing system 402 determines if new user feedback has been uploaded to the collaboration session from the client computing device(s) 406. If no new user feedback has been uploaded to the collaboration session from the client computing devices(s) 406, host computing system 402 returns to 420. Alternatively, if new user feedback has been uploaded to the collaboration session from the client computing device(s) 406, host computing system 402 proceeds to 452, where host computing system 402 stores the newly uploaded user feedback and associates the stored user feedback with the photograph(s) to which the user feedback corresponds. Then, at 454, host computing system 402 distributes the received feedback to the client computing device(s) engaged in the collaboration session as leaders (i.e., client computing device 402). For example, in implementations in which the collaboration session is implemented as an HTTP connection between host computing system 402 and client computing device 404 and one or more HTTP connections between host computing system 402 and client computing device(s) 406, host computing device 402 may use the HTTP connection between host computing system 402 and client computing device 404 to transmit an indication to client computing device 404 that new user feedback associated with one or more photographs is available for download to client computing device 404.

Meanwhile, at 456, client computing device 404 determines whether there is any new user feedback that has been uploaded to the collaboration session that is available for download. If client computing device 404 determines that new user feedback is available for download, client computing device 404 proceeds to 458, where client computing device 404 downloads the new user feedback and displays it in a manner that reflects the association between the downloaded feedback and the photograph(s) to which it corresponds. For example, in implementations in which the collaboration session is implemented as an HTTP connection between host computing system 402 and client computing device 404 and one or more HTTP connections between host computing system 402 and client computing device(s) 406, client computing device 404 may include a listener to detect communications within the established HTTP connection from host computing system 402 indicating that new user feedback is available for download and to trigger download of such new user feedback via the established HTTP connection in response. Alternatively, if client computing device 404 determines that no new user feedback is available for download, client computing device 404 returns to 434 and determines whether a new user instruction to upload a photograph to the collaboration session has been received.

Referring again to 438, when host computing system 402 determines that no new photographs have been uploaded to the collaboration session before the collaboration session times out, host computing system proceeds to 460 and terminates the collaboration session. Thereafter, at 462, host computing system 402 provides intelligence gleaned from the collaboration session to one or more third party business organizations. For example, if the collaboration session involved a collaborative shopping effort where the photographs uploaded to the collaboration session represented items being considered for potential purchase by a shopper and the feedback about the photographs represented user opinions about the items being considered for purchase, intelligence about what products the shopper was considering for purchase and the user feedback received in connection with such potential purchasers may be provided to one or more third party business organizations. Additionally or alternatively, in some implementations, host computing system 402 may solicit information from the shopper about which, if any, of the items the shopper was considering for purchase that the shopper ultimately purchased. In such implementations, this purchase implementation also may be provided to one or more third party business organizations.

A number of methods, techniques, systems, and apparatuses have been described. However, other variations are contemplated and within the scope of this disclosure. For instance, while FIGS. 1A-1F illustrate examples of GUIs for an application for enabling collaborative reactions to images, different GUIs may be employed for such applications for enabling collaborative reactions to images. For example, FIG. 5 is a schematic diagram that illustrates a GUI 500 that is an alternative to the GUI 143 illustrated in FIG. 1D for presenting a view of preference votes compiled from different users participating in a collaborative shopping session for the different images 114, 118, 136, and 138 uploaded to the collaborative shopping session by the shopper using device 100. As illustrated in FIG. 5, in addition to the number of “Yes,” “No,” and “Maybe” votes recorded on behalf of other users participating in the collaborative shopping session for each of the different images 114, 118, 136, and 138 displayed by GUI 143 of FIG. 1D, GUI 500 also includes a map interface 502 and geographic location indicators 504(a), 504(b), 504(c), and 504(d) associated with each of the different images 114, 118, 136, and 138, respectively, that are displayed in connection with the map interface 502 in a manner that reflects geographic locations associated with each of the different images 114, 118, 136, and 138. In some implementations, images 114, 118, 136, and 138 may be photographs, and the geographic locations associated with each of the different images 114, 118, 136, and 138 may correspond to locations at which the photographs were taken. In alternative implementations, the geographic locations associated with each of the different images 114, 118, 136, and 138 may correspond to locations at which the images were uploaded to the collaboration session.

The described methods, techniques, systems, and apparatuses may be implemented in digital electronic circuitry or computer hardware, for example, by executing instructions stored in computer-readable storage media.

Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order and/or in certain combinations, in some implementations, individual operations may be rearranged in a different order, combined with other operations described herein, and/or eliminated, and the desired results still may be achieved. Similarly, components in the disclosed systems may be combined in a different manner and/or replaced or supplemented by other components and the desired results still may be achieved.

What is claimed is:

1. A computer system comprising:
one or more processing elements; and
computer memory storing instructions that, when executed by the one or more processing elements, cause the computer system to:
provide temporary chat room instances such that an individual temporary chat room instance is invokable by a leader identity and is accessible by a restricted group of participant identities;
present, within a particular temporary chat room instance invoked by a particular leader identity, photographs of different products being considered for purchase by a user associated with the particular leader identity, the presented photographs having been received by the computer system on behalf of the particular leader identity;
establish associations between:
reactions to different ones of the products represented in the presented photographs received by the computer system on behalf of at least some of the particular participant identities to which the particular temporary chat room instance is restricted, and
the photographs to which the received reactions correspond; and
provide, within the particular temporary chat room instance and to a user associated with the particular leader identity, indications of the received reactions to different ones of the products represented in the presented photographs in a manner that reflects the established associations between the received reactions and the photographs to which the received reactions correspond.

2. Non-transitory, computer-readable storage storing instructions that, when executed by a computer system, cause the computer system to:
launch a collaboration session for which participation involves a particular user identity and one or more other user identities;
receive, in connection with the collaboration session, an image provided on behalf of the particular user identity;
enable one or more users associated with the one or more other user identities to access the image via the collaboration session;
receive, in connection with the collaboration session, a reaction to the image provided on behalf of an individual one of the other user identities;
establish an association between the received reaction and the image that links the received reaction to the image; and
enable a user associated with the particular user identity to access, in connection with the collaboration session, the received reaction in a manner that reflects the link between the received reaction and the image.

3. A computer-implemented method comprising:
providing, by a computing system, a collaboration service enabling collaboration sessions involving multiple user identities;
receiving, by the computing system, a request to establish, on behalf of a particular user identity, a collaboration session;
launching, by the computing system, the requested collaboration session, the collaboration session being accessible to a user associated with the particular user identity and one or more users associated with one or more other user identities via a network address associated with the collaboration session;
receiving, by the computing system, an indication of an image provided on behalf of the particular user identity to be associated with the collaboration session;
enabling, by the computing system, one or more users associated with the one or more other user identities to access the image in connection with the collaboration session;
enabling, by the computing system, one or more users associated with the one or more other user identities to provide reactions to the image in connection with the collaboration session;
as a consequence of having enabled one or more users associated with the one or more other user identities to provide reactions to the image, receiving, by the computing system and in connection with the collaboration session, a reaction to the image provided on behalf of an individual one of the other user identities;
establishing, by the computing system, an association between the received reaction and the image that links the received reaction to the image; and
enabling, by the computing system, a user associated with the particular user identity to access the received reaction in a manner that reflects the link between the received reaction and the image.

4. The method of claim 3 wherein:
receiving an indication of an image provided on behalf of the particular user identity to be associated with the collaboration session includes receiving indications of multiple different images provided on behalf of the particular user identity;
enabling one or more other users associated with the one or more other user identities to access the image in connection with the collaboration session includes enabling one or more users associated with the one or more other user identities to access the multiple different images in connection with the collaboration session; and
enabling one or more users associated with the one or more other user identities to provide reactions to the image in connection with the collaboration session includes enabling one or more other users associated with the one or more other user identities to provide reactions to each of the multiple different images, the method further comprising:
as a consequence of having enabled one or more users associated with the one or more other user identities to provide reactions to each of the multiple different images, receiving, in connection with the collaboration session, additional reactions provided on behalf of at least some of the other user identities to at least some of the multiple different images, each additional reaction corresponding to an individual one of the multiple different images,
establishing associations between the additional received reactions and their corresponding images that link the additional received reactions to their corresponding images, and
enabling, by the computing system, a user associated with the particular user identity to access the additional received reactions in a manner that reflects the links between the additional received reactions and their corresponding images.

5. The method of claim 4 wherein:
enabling one or more users associated with the one or more other user identities to provide reactions to each of the multiple different images includes is enabling one or more users associated with the one or more other user identities to select an indication of a relative preference level for each of the multiple images from among a predefined selection of at least two indications of relative preference levels;
receiving additional reactions provided on behalf of at least some of the other user identities to at least some of the multiple different images includes receiving indications of selections of relative preference levels provided on behalf of at least some of the other user identities for at least some of the multiple different images;
establishing associations between the additional received reactions and their corresponding images that link the additional received reactions to their corresponding images includes establishing associations between the received indications of selections of relative preference levels to their corresponding images; and
enabling a user associated with the particular user identity to access the additional received reactions in a manner that reflects the links between the additional received reactions and their corresponding images includes tallying the received indications of selections of relative preference levels for each of the multiple different images.

6. The method of claim 4 wherein:
enabling one or more users associated with the one or more other user identities to provide reactions to each of the multiple different images includes enabling one or more users associated with the one or more other user identities to provide free text comments for each of the multiple images;
receiving additional reactions provided on behalf of at least some of the other user identities to at least some of the multiple different images includes receiving free text comments provided on behalf of at least some of the other user identities for at least some of the multiple different images;
establishing associations between the additional received reactions and their corresponding images that link the additional received reactions to their corresponding images includes establishing associations between the received free text comments and their corresponding images; and
enabling a user associated with the particular user identity to access the additional received reactions in a manner that reflects the links between the additional received reactions and their corresponding images includes enabling a user associated with the particular user identity to access the received free text comments in a manner that reflects the links between the received free text comments and their corresponding images.

7. The method of claim 3 wherein:
launching the requested collaboration session includes launching the requested collaboration session to run until occurrence of a terminating condition;
enabling one or more users associated with the one or more other user identities to access the image in connection with the collaboration session includes enabling one or more users associated with the one or more other user identities to access the image in connection with the collaboration session for a temporary period of time until the occurrence of the terminating condition; and
enabling one or more users associated with the one or more other user identities to provide reactions to the image in connection with the collaboration session includes enabling one or more users associated with the one or more other user identities to provide reactions to the image in connection with the collaboration session for a temporary period of time until the occurrence of the terminating condition.

8. The method of claim 7 further comprising:
detecting occurrence of the terminating condition; and
responsive to detecting the occurrence of the terminating condition disabling users associated with the one or more other user identities from accessing the collaboration session.

9. The method of claim 7 further comprising:
detecting occurrence of the terminating condition; and
responsive to detecting the occurrence of the terminating condition disabling users associated with the particular user identity and users associated with the one or more other user identities from accessing the collaboration session.

10. The method of claim 7 wherein:
launching the requested collaboration session to run until occurrence of a terminating condition includes launching the requested collaboration session to run until a predetermined period of time elapses during which no indications of additional images provided on behalf of the particular user identity to be associated with the collaboration session are received;
enabling one or more users associated with the one or more other user identities to access the image in connection with the collaboration session for a temporary period of time includes enabling one or more users associated with the one or more other user identities to access the image in connection with the collaboration session until the predetermined period of time elapses during which no indications of additional images provided on behalf of the particular user identity to be associated with the collaboration session are received;
enabling one or more users associated with the one or more other user identities to provide reactions to the image in connection with the collaboration session for a temporary period of time includes enabling one or more users associated with the one or more other user identities to provide reactions to the image in connection with the collaboration session until the predetermined period of time elapses during which no indications of additional images provided on behalf of the particular user identity to be associated with the collaboration session are received, the method further comprising:
detecting that the predetermined period of time has elapsed during which no indications of additional images provided on behalf of the particular user identity to be associated with the collaboration session are received, and
responsive to detecting that the predetermined period of time has elapsed during which no indications of additional images provided on behalf of the particular user identity to be associated with the collaboration session are received, disabling users associated with the one or more other user identities from accessing the collaboration session.

11. The method of claim 7 wherein:
launching the requested collaboration session to run until occurrence of a terminating condition includes launching the requested collaboration session to run until a request to terminate the collaboration session on behalf of the particular user identity is received;
enabling one or more users associated with the one or more other user identities to access the image in connection with the collaboration session for a temporary period of time includes enabling one or more users associated with the one or more other user identities to access the image in connection with the collaboration session until a request to terminate the collaboration session on behalf of the particular user identity is received;
enabling one or more users associated with the one or more other user identities to provide reactions to the image in connection with the collaboration session for a temporary period of time includes enabling one or more users associated with the one or more other user identities to provide reactions to the image in connection with the collaboration session until a request to terminate the collaboration session on behalf of the particular user identity is received, the method further comprising:
receiving a request on behalf of the particular user identity to terminate the collaboration session, and
responsive to receiving the request on behalf of the particular user identity to terminate the collaboration session, disabling users associated with the one or more other user identities from accessing the collaboration session.

12. The method of claim 3 wherein receiving an indication of an image provided on behalf of the particular user identity to be associated with the collaboration session includes receiving an indication of a product represented by the image and geographic coordinates associated with a location at which the product is available for purchase in addition to the indication of the image, the method further comprising:
identifying a business organization corresponding to the received geographic coordinates;
establishing an association between the received reaction, the indication of the product represented by the image, and the identified business organization; and
storing the association between the received reaction, the indication of the product represented by the image, and the identified business organization in a computer memory storage system.

13. The method of claim 12 further comprising receiving an indication of a purchase decision for the product represented by the image provided on behalf of the particular user identity, wherein:
establishing an association between the received reaction, the indication of the product represented by the image, and the identified business organization includes establishing an association between the received reaction, the indication of the product represented by the image, the identified business organization, and the purchase decision, and
storing the association between the received reaction, the indication of the product represented by the image, and the identified business organization in a computer memory storage system includes storing the association between the received reaction, the indication of the product represented by the image, the identified business organization, and the purchase decision in the computer memory storage system.

14. The method of claim 3 wherein receiving an indication of an image provided on behalf of the particular user identity to be associated with the collaboration session includes receiving an indication of a product represented by the image in addition to the indication of the image, the method further comprising:
receiving an indication of a purchase decision for the product represented by the image provided on behalf of the particular user identity;
establishing an association between the purchase decision and the indication of the product represented by the image; and
storing the association between the purchase decision and the indication of the product represented by the image in a computer memory storage system.

15. The method of claim 3 wherein:
receiving an indication of an image provided on behalf of the particular user identity to be associated with the collaboration session includes receiving, from a computing device, a photograph of a product being considered for purchase by a user associated with the user identity;
enabling one or more users associated with the one or more other user identities to access the image in connection with the collaboration session includes enabling one or more users associated with the one or more other user identities to access the photograph of the product being considered for purchase via the network address;
enabling one or more users associated with the one or more other user identities to provide reactions to the image in connection with the collaboration session includes enabling one or more users associated with the one or more other user identities to provide reactions to the photograph of the product being considered for purchase via the network address;
receiving, in connection with the collaboration session, a reaction to the is image provided on behalf of an individual one of the other user identities includes receiving, in connection with the collaboration session, a reaction to the photograph of the product being considered for purchase provided on behalf of an individual one of the user identities;
establishing an association between the received reaction and the image that links the received reaction to the image includes establishing an association between the received reaction and the photograph of the product being considered for purchase; and
enabling a user associated with the particular user identity to access the received reaction in a manner that reflects the link between the received reaction and the image includes enabling a user associated with the particular user identity to access the received reaction in a manner that reflects the link between the received reaction and the photograph of the product being considered for purchase.
